(19) United States
(12) Patent Application Publication
(10) Pub. No.: US 2025/0333265 A1
(43) Pub. Date: Oct. 30, 2025

(54) MODULAR COMPUTING SYSTEM AND PEOPLE MOVEMENT MANAGEMENT SYSTEM

(71) Applicant: KONE CORPORATION, Helsinki (FI)

(72) Inventors: Matti Laakso, Helsinki (FI); Aleksi Muotka, Helsinki (FI); Toni Lammi, Helsinki (FI)

(73) Assignee: KONE CORPORATION, Helsinki (FI)

(21) Appl. No.: 19/261,387

(22) Filed: Jul. 7, 2025

Related U.S. Application Data
(63) Continuation of application No. PCT/FI2023/050016, filed on Jan. 9, 2023.

(51) Int. Cl. B66B 1/34

(52) U.S. Cl. CPC B66B 1/3461; B66B 1/343

(57) ABSTRACT

A modular computing system (100) for a people movement management system (200), and a people movement management system (200) are provided herein. The modular computing system (100) comprises one or several computing modules (32A, 32N), each comprising a processing unit in connection with a memory, and an input/output connection interface (33A, 33N) for providing connection with one or several input/output units (34A, 34B, 34N). At least one of the computing modules (32A, 32N) is configured to monitor its performance and/or performance of at least one other of the computing modules (32A, 32N), and allocate computing resources of the computing modules (32A, 32N) based on said performance monitoring for executing control program portions included in one or several software containers, wherein the allocation is implemented based on pre-defined criticality ratings for functions of the people movement management system (200). The computing module(s) (32A, 32N) is/are configured to execute the control program portions based on the allocation of the computing resources.

### FIELD OF THE INVENTION

The present invention relates in general to computing systems. In particular, however, not exclusively, the present invention concerns a modular computing system for providing digital services in a people movement management system designed for managing and providing transportation for people and material within a building, such as including an elevator, an escalator, a moving walkway, and/or an automatic door, etc.

### BACKGROUND

Providing digital services for an entity, for example, for a building owner and/or the building itself, nowadays typically requires that there is a communication connection either at least to a local network, and/or to a cloud service or other external server system. Depending on the type of digital services to be provided, connectivity and computing devices may have different requirements regarding performance, cybersecurity, and/or service availability.

Connectivity and computing devices are typically designed with a particular purpose in mind. If two different services are provided to two different entities, typically two different devices are delivered, both with different software running thereon. Hardware and software maintenance (for example, component changes and security updates) are thus done separately for each of the devices. If yet another service is provided to a further entity, still another piece of hardware and related software that fulfills the requirements of the new service must be delivered and installed. This leads to increase in maintenance efforts to keep all these solutions running as well as of amount physical hardware. Thus, there is still a need to develop computing systems for providing plurality of digital services which are easier to manage and maintain.

### SUMMARY

An objective of the present invention is to provide a modular computing system for a people movement management system and a people movement management system. Another objective of the present invention is that the modular computing system and the people movement management system which computing solutions, both relative to software and hardware, are easier to manage and maintain.

The objectives of the invention are reached by a modular computing system for a people movement management system and a people movement management system as defined by the respective independent claims.

According to a first aspect, a modular computing system for a people movement management system is provided. The modular computing system comprises one or several computing modules, each comprising a processing unit in connection with a memory, and an input/output connection interface for providing connection with one or several input/output units. At least one of the computing modules is configured to monitor its performance and/or performance of at least one other of the computing modules, and allocate computing resources of the computing modules based on said performance monitoring for executing control program portions included in one or several software containers, wherein the allocation is implemented based on pre-defined criticality ratings for functions of the people movement management system. The one or several computing modules are configured to execute the control program portions based on the allocation of the computing resources, and a plurality of input/output units connected to the one or several computing modules for use when executing the control program portions by the one or several computing modules.

Software containers are defined in this application to refer to software entity providing resource isolation between multiple instances on the same hardware but otherwise behaving like an operating system and which can execute applications. Thus, the software containers, despite of including level of isolation (and thus security and easier management through isolation), differ from a Virtual Machine which runs on its own full operating system. The software containers share the host's operating system kernel. Containers are thus modular in that they can be created once, and of course may be updated afterwards, and used multiple times without additional attention.

In various embodiments, the modular computing system may comprise a plurality of computing modules. Thus, said at least one of the computing modules may be configured to monitor performance of another computing modules.

Furthermore, alternatively or in addition, the plurality of input/output units may be selected from the group consisting of: a camera, a display screen, a serial interface, a sensor.

In various embodiments, the modular computing system may comprise a communication unit. Optionally, the communication unit may be arranged to communicate with an external server system, such as with a cloud computing system. Furthermore, the modular computing system may be configured to receive instructions from the external server system to run control program portions of the one or several software containers.

Alternatively or in addition, the at least one computing module may be a programmable logic controller.

In some embodiments, the modular computing system may include criticality rating pre-assigned for each of the control program portions including instructions related to the functions of the people movement management system, wherein the at least one of the computing modules is configured to allocate the control program portions to be executed by the computing modules based on the pre-assigned criticality rating so that computing resources are prioritized at least for the most critical control program portions. In addition, optionally, the most critical control program portions may include safety-critical functions of the of the people movement management system.

The modular computing system may further be connected to an operator's workstation.

In case of multiple computing modules, failure of one module can be temporarily tolerated by orchestrating most important services to the other module(s) automatically.

Furthermore, wherein, in case of detection of a faulty computing module, the at least one of the computing modules may be configured to allocate computing tasks previously executed by the faulty computing module to another one of the computing modules.

According to a second aspect, a people movement management system is provided. The people movement management system comprises a modular computing system in accordance with the first aspect. In addition, at least one of the plurality of input/output units is arranged to provide information about movement of people at a site of the modular computing system.

The people movement management system may comprise a controller for controlling operation of a people movement management system at the site. The controller may, preferably, be connected to or be comprised in the modular computing system.

Furthermore, the people movement management system may include an elevator system, the elevator system comprising at least one elevator car movable in an elevator shaft, and the controller, being an elevator controller, is configured to control operation of the elevator system.

Alternatively or in addition, the people movement management system may include a personal conveying system, such as an escalator or a moving walkway, and the controller, being a personal conveying system controller, is configured to control operation of the personal conveying system.

Furthermore, the people movement management system may comprise at least one automatic door, and the controller, being an automatic door controller, is configured to control operation of the at least one automatic door.

The present invention provides a modular computing system for a people movement management system and a people movement management system. The present invention provides advantages over known solutions in that only a single well-defined base software (stack) needs to be maintained. Software or I/O (input/output) units for new services can be updated, developed, and delivered independently from other hardware and software. Advantageously, standardized interfaces are used.

Furthermore, I/O units can be added independently, so if several services are provided to an entity, such as to operate in connection with an elevator, only one computing module, preferably a standard computing module, with sufficient performance can be delivered along with the necessary I/O units. If a new service is then provided to the entity, depending on whether it needs new I/O interfaces and/or units or more computing power, only the related I/O unit or additional computing unit can be delivered.

Still further, software containers in the system can be updated independently from each other. If code or standard imposes limitations on software upgradability, other containers can still be updated without violating the requirement.

Software in the containers may only communicate with each other using separately approved channels and protocols, providing isolation and security, also for software developed by third parties.

Various other advantages will become clear to a skilled person based on the following detailed description.

The expression “a plurality of” may refer to any positive integer starting from two (2), that is, two, at least two, three, at least three, etc.

The terms “first”, “second” etc. are herein used to distinguish one element from another element, and not to specially prioritize or order them, if not otherwise explicitly stated. The exemplary embodiments of the present invention presented herein are not to be interpreted to pose limitations to the applicability of the appended claims. The verb “to comprise” is used herein as an open limitation that does not exclude the existence of also unrecited features. The features recited in the claims are mutually freely combinable unless otherwise explicitly stated.

The novel features which are considered as characteristic of the present invention are set forth in particular in the appended claims. The present invention itself, however, both as to its construction and its method of operation, together with additional objectives and advantages thereof, will be best understood from the following description of specific embodiments when read in connection with the accompanying drawings.

### BRIEF DESCRIPTION OF FIGURES

Some embodiments of the invention are illustrated by way of example, and not by way of limitation, in the figures of the accompanying drawings.

FIG. 1 illustrates schematically a modular computing system.

FIG. 2 illustrates schematically a people movement management system.

### DETAILED DESCRIPTION OF SOME EMBODIMENTS

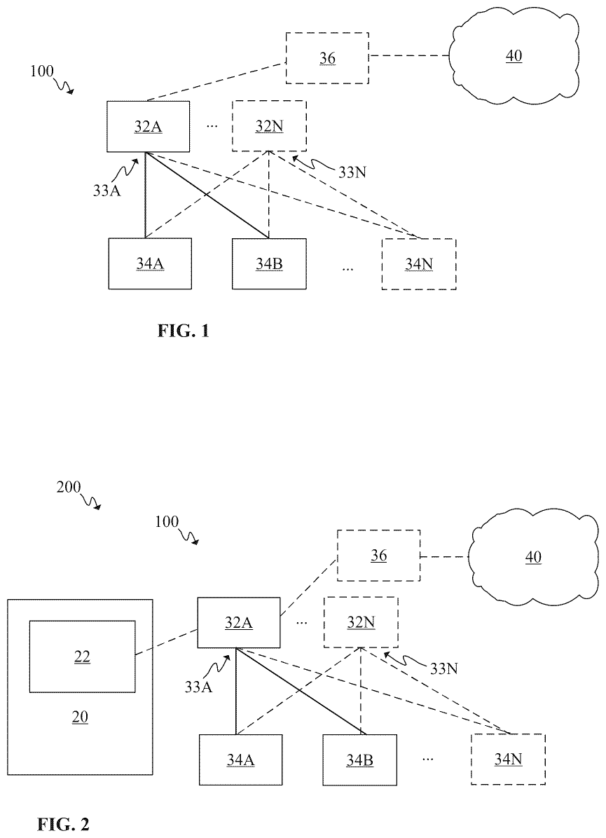

FIG. 1 illustrates schematically a modular computing system 100. The modular computing system 100 may, preferably, be arranged comprised in or to be in connection with a people movement management system 200 designed for managing and providing transportation for people and material within a building, such as including an elevator, an escalator, a moving walkway, and/or an automatic door, etc. that is, one or a combination of the aforesaid. Dashed lines indicated optional features.

The modular computing system 100 comprises one or several computing modules 32A, 32N, each comprising a processing unit in connection with a memory, and an input/output connection interface 33A, 33N for providing connection with one or several input/output units 34A, 34B, 34N. At least one of the computing modules 32A, 32N is configured to monitor its 32A, 32N performance and/or performance of at least one other of the computing modules 32A, 32N, and allocate computing resources of the computing modules 32A, 32N based on said performance monitoring for executing control program portions included in one or several software containers, wherein the allocation is implemented based on pre-defined criticality ratings for functions of a host system, for example, of the people movement management system 200. Said one or several computing modules 32A, 32N are configured to execute the control program portions based on the allocation of the computing resources. A plurality of input/output units 34A, 34B, 34N are connected to the one or several computing modules 32A, 32N for use when executing the control program portions by the one or several computing modules 32A, 32N. In FIG. 1, a plurality of computing modules 32A, 32N, that is two or more, are shown, however, in some cases there could be only one. Thus, computing capabilities may be provided with standardized computing modules that can be connected to I/O units with differing physical interfaces for different needs.

Software providing different services may thus be delivered in standardized containers. Software containers can be added and removed freely, provided that the required I/O is in place, and that the compute performance is sufficient for all services.

In case of plurality of computing modules 32A, 32N, in case of detection of a faulty computing module, one or more of the computing modules 32A, 32N may be configured to allocate computing tasks previously executed by the faulty computing module to another one of the computing modules 32A, 32N.

The pre-defined criticality ratings may include, for example, a priority value or number assigned to the functions. For example, each of the pre-defined or known functions may have its own place in the priority list of all of the functions. Alternatively, the functions may be grouped into priority groups, in which case functions in the same group may be allocated resources based on chronological order. Other ways of prioritizing the functions may also be used. Computing resources may thus be allocated to the software containers based on their criticality. This may mean stopping or preventing some functions to be performed or executed.

Furthermore, the modular computing system 100 may be configured to issue a warning in a suitable form, such as visible and/or audible, to the operator about lack of computing power. For example, there may be a threshold set so that the if there are less computing resources available than the threshold, such as 10 or 20 percent of all resources, or number of processors or computing units. This indication may be utilized to arranged another computing module to the system.

Thus, in various embodiments, the modular computing system 100 may include criticality rating pre-assigned for each of the control program portions including instructions related to the functions of the people movement management system 200. The at least one of the computing modules 32A, 32N may be configured to allocate the control program portions to be executed by the computing modules 32A, 32N based on the pre-assigned criticality rating so that computing resources are prioritized at least for the most critical control program portions. Furthermore, the most critical control program portions may include safety-critical functions of the host system, such as the people movement management system 200. In case of elevators, for example, these may mean safety circuit related functions, or emergency phones and/or lighting inside an elevator car.

Safety circuit related functions, as known to a skilled person, relate more or less directly to the operation of the elevator components and devices related to moving and braking the elevator car, and opening and closing elevator car doors and elevator shaft doors, or landing floor doors, to name few examples. In some embodiments, these are monitored and operated by elevator controller, however, one, some, or even all of these may in other embodiments be performed by the modular computing system 100. In those cases, these functionalities have the highest priority or criticality rating in the modular computing system 100.

Other features or functionalities which may assigned the highest criticality rating may include emergency phones in the elevator car(s). In some embodiments, these may be assigned the second highest criticality rating if the system is configured to also perform some safety circuit related functions. The emergency phone may be operated via a two-directional communication connection transferring audio signals. Furthermore, there can also be text-based messaging supported. In some embodiments, the emergency phone is also arranged to operate on a two-directional video connection. The video connection may be assigned with a lower criticality rating than the sound and/or text-based connection. Thus, if the performance of the modular computing unit 100 is low, the video connection of the emergency phone system can be disabled to preserve computing resources for sound and/or text-based communication.

Another example may be criticality rating assigned to analyzing data from sensors of the elevator system. The highest criticality rating may be assigned to data related to monitoring operation of the elevator machinery, such as related to moving of the elevator car. Lower critically rating may be assigned to analyzing video or photo-based data from a camera installed into the site or premises of the people movement management system 200. Still further, there may be different criticality ratings assigned for analyzing video data for different purposes. A higher value may be assigned for detecting electric scooter or wheelchairs or the like whereas a lower value may be assigned for counting number of persons in the video or photo. Finally, the lowest level of criticality rating may be assigned to comfort or entertaining functions, such as background music, advertisements in a display, or other such media services.

In various embodiments, the same input/output unit 34A, 34B may be utilized for two or more functions having different criticality ratings. For example, the speaker of the emergency phone may be assigned a high criticality rating when used for an emergency call. On the other hand, the same speaker may be used for playing background music with a low criticality rating. Thus, if the computing resources are running low, the background music can be stopped based on the criticality rating order, and the use of speaker continued for emergency calls.

The plurality of input/output units 34A, 34B may include various devices utilizable, for example, in a people movement management system 200. In some embodiments, the plurality of input/output units 34A, 34B may be selected from the group consisting of: a camera, a display screen, a serial interface, a sensor.

In various embodiments, the modular computing system 100 may comprise a communication unit 36. The communication unit 36 may be a separate device, such as a router or the like, or it may be integrated into one or several computing units 32A, 32N, or other devices of the system 100. Connectivity may thus be provided with a dedicated connectivity module if needed, however, also existing network infrastructure can be used to provide connectivity.

The communication unit 36 may be arranged to communicate with an external server system 40, such as with a cloud computing system. For example, the modular computing system 100 may be configured to receive instructions from the external server system 40 to run control program portions of the one or several software containers.

In various embodiments, the computing modules 32A, 32N on a single site form a cluster, and an external server system 40, such as based on cloud computing, may assign the cluster to run the software containers depending on the services provided to the site.

Software container orchestration software running in the cluster may assign software containers inside the site to run on different computing modules 32A, 32N depending on the required compute capabilities (e.g. video processing) and I/O (e.g. connected sensors).

Regarding the computing module(s) 32A, 32N, it or one or more of them, preferable each one of them may be a programmable logic controller (PLC), which are flexible, rugged and easily programmable. PLCs even further improve the modularity aspect of the computing system 100 compared to other computing modules since PLCs are easy to program and manage since there are industrial standards defined for programming and operation of PLCs.

In various embodiments, the modular computing system 100 may further be connected to an operator's workstation. Thus, the modular computing system 100 may send and/or receive data from the operator's workstation. The operator may then receive data from the modular computing system 100 and from another system connected to the workstation, and thus manage several different systems.

FIG. 2 illustrates schematically a people movement management system 200. As stated hereinbefore, the people movement management system 200 may include, for example, one or a combination of an elevator 20, an escalator, a moving walkway, and/or an automatic door. In FIG. 2, only an elevator 20 is schematically illustrated. Furthermore, the people movement management system 200 comprises a modular computing system 100 in accordance with what is described hereinabove. Still further, at least one of the plurality of input/output units 34A, 34B, 34N is arranged to provide information about movement of people at a site, such as in a building, of the modular computing system 100. Dashed lines indicated optional features.

In preferable embodiments, the people movement management system 200 may comprises a controller 22 for controlling operation of a people movement management system 200 at the site. The controller 22 may, preferably, be connected to or be comprised in the modular computing system 100.

In some embodiments, the most critical of the safety-critical functions may be isolated to be performed by the controller 22. Alternatively or in addition, these most critical of the safety-critical functions may, at least some of them or all of them, be performed by the modular computing system 100.

The controller 22 may, for example, by utilized to monitor safety circuit related functions and control drive or hoisting mechanism of the elevator 20, if the people movement management system 200 includes an elevator 20. Thus, the controller 22 may be an elevator controller.

As understood by a skilled person, an elevator 20 or elevator system comprises various known elements, sub-systems and devices, although them not being shown in FIG. 1 or 2. For example, the elevator 20 typically comprises an elevator car movable in an elevator shaft. The elevator car is controlled so that it moves in the shaft and is selectively stopped at landings. The movement of the elevator car may be provided with a rotating sheave operated by an electric motor and, for example, a frequency converter to control the electric motor. There may be hoisting rope or the like, or the motor may be a linear motor. Furthermore, the elevator may include a hydraulic system for moving the elevator car or cars. The elevator 20 may also comprise sensors, such as movement and/or position sensors, and various safety devices, such as brake and buffers or so. Similar applies also to other alternatives or sub-systems of the people movement management system 200, such as to an escalator, a moving walkway, and/or an automatic door. Each of these have at least some minimum devices or means to perform their basic functioning. All of them also, typically, have safety-related functions too, as known.

Thus, the people movement management system 200 may include a personal conveying system, such as an escalator or a moving walkway, and the controller, being a personal conveying system controller, may be configured to control operation of the personal conveying system.

Alternatively or in addition, the people movement management system 200 may comprises at least one automatic door, and the controller, being an automatic door controller, is configured to control operation of the at least one automatic door.

As stated hereinbefore, the people movement management system 200 may comprise one or more of the aforesaid sub-systems, such as in a building having one or more elevators 20, one or more escalators and/or moving walkways, and/or one or more automatic doors. The people movement management system 200 may in many cases cover various elements operating together or at least being connected to a common control system, such as having the modular computing system 100, for collecting information from various sources and operating various sub-systems to advantageously control flow of people within the site.

1. A modular computing system for a people movement management system, comprising:
one or several computing modules, each comprising a processing unit in connection with a memory, and an input/output connection interface for providing connection with one or several input/output units, wherein at least one of the computing modules is configured to:
monitor its performance and/or performance of at least one other of the computing modules, and
allocate computing resources of the computing modules based on said performance monitoring for executing control program portions included in one or several software containers, wherein the allocation is implemented based on pre-defined criticality ratings for functions of the people movement management system,
wherein the one or several computing modules are configured to execute the control program portions based on the allocation of the computing resources; and
a plurality of input/output units connected to the one or several computing modules for use when executing the control program portions by the one or several computing modules.

2. The modular computing system of claim 1, wherein the modular computing system comprises a plurality of computing modules.

3. The modular computing system of claim 1, wherein the plurality of in-put/output units are selected from the group consisting of: a camera, a display screen, a serial interface, a sensor.

4. The modular computing system of claim 1, comprising a communication unit.

5. The modular computing system of claim 4, wherein the communication unit is arranged to communicate with an external server system, such as with a cloud computing system.

6. The modular computing system of claim 5, configured to receive instructions from the external server system to run control program portions of the one or several software containers.

7. The modular computing system of claim 1, wherein the at least one computing module is a programmable logic controller.

8. The modular computing system of claim 1, including criticality rating pre-assigned for each of the control program portions including instructions related to the functions of the people movement management system, wherein the at least one of the computing modules is configured to allocate the control program portions to be executed by the computing modules based on the pre-assigned criticality rating so that computing resources are prioritized at least for the most critical control program portions.

9. The modular computing system of claim 8, wherein the most critical control program portions include safety-critical functions of the of the people movement management system.

10. The modular computing system of claim 1, further connected to an operator's workstation.

11. The modular computing system of claim 2, wherein, in case of detection of a faulty computing module, the at least one of the computing modules is configured to allocate computing tasks previously executed by the faulty computing module to another one of the computing modules.

12. A people movement management system, comprising:
a modular computing system of claim 1; and
wherein at least one of the plurality of input/output units is arranged to provide information about movement of people at a site of the modular computing system.

13. The people movement management system of claim 12, comprising a controller for controlling operation of a people movement management system at the site.

14. The people movement management system of claim 13, including an elevator system, the elevator system comprising at least one elevator car movable in an elevator shaft, and the controller, being an elevator controller, is configured to control operation of the elevator system.

15. The people movement management system of claim 13, including a personal conveying system, such as an escalator or a moving walkway, and the controller, being a personal conveying system controller, is configured to control operation of the personal conveying system.

16. The people movement management system of claim 13, comprising at least one automatic door, and the controller, being an automatic door controller, is configured to control operation of the at least one automatic door.

17. The modular computing system of claim 2, wherein the plurality of in-put/output units are selected from the group consisting of: a camera, a display screen, a serial interface, a sensor.

18. The modular computing system of claim 2, comprising a communication unit.

19. The modular computing system of claim 3, comprising a communication unit.

20. The modular computing system of claim 2, wherein the at least one computing module is a programmable logic controller.
